(19) United States
(12) Patent Application Publication
(10) Pub. No.: US 2003/0110068 A1
(43) Pub. Date: Jun. 12, 2003

(54) System for exchanging materials

(76) Inventors: Lesley R. Matheson, Berwyn, PA (US); David Rossi, Berwyn, PA (US); Timothy Cottrell, Lawrenceville, NJ (US)

Correspondence Address: ROBERT E. CANNUSCIO, DRINKER BIDDLE & REATH LLP, One Logan Square, 18th & Cherry Streets, Philadelphia, PA, 19103-6996, US

(21) Appl. No.: 10/077,498

(22) Filed: Feb. 15, 2002

Related U.S. Application Data
(60) Provisional application No. 60/339,097, filed on Dec. 10, 2001.

(51) Int. Cl. G06F 17/60

(52) U.S. Cl. 705/8

(57) ABSTRACT

A method of facilitating the exchange of bulk materials is provided. The method involves receiving and storing in a searchable database postings from potential providers of excess materials regarding their respective excesses. The posting includes information indicative of the material, such as its composition, location, source, and contact information for the potential provider. Potential acceptors of material search and view the postings, rather than purchase newly quarried material. The potential acceptors can also post descriptions of their needs. The database is searched, comparing the descriptions of the needs with postings of the excesses. Information about compatible excesses or needs found to correspond with a user's need or excess are then displayed to the user, with information regarding the location of the material relative to the need.

### RELATED APPLICATION

This application is related to and claims priority from Provisional Patent Application Serial No. 60/339,097, filed Dec. 10, 2001, titled “System For Exchanging Materials”. That Provisional Application is incorporated herein by reference in its entirety.

### FIELD OF THE INVENTION

The invention relates to the distribution and exchange of bulk materials and machinery. The invention is ideally suited for facilitating the exchange of bulk materials and machinery in connection with the field of excavation and heavy civil construction.

### BACKGROUND OF THE INVENTION

A number of industries face problems relating to bulk material exchange. Land development is an industry that faces the problems frequently. In fact, a land developer may be concerned about excess materials at a job site, or shortages of same, on a daily basis. Although bulk materials can be of many varieties, soil is one of the most common. Soil itself, however, is greatly variable, some soil being acceptable for certain uses, while some soil is not. In fact, soil can be characterized in a variety of different ways. Factors effecting the suitability of soil for a particular purpose include contaminant levels, composition, properties, and source. Other types of bulk materials include aggregates, such as sand, rock, and gravel, all of which vary in characteristics as much as soil.

In the field of land development, excavation is almost always performed in advance of or during significant projects. Often, excavation creates an excess of dirt on the job site, requiring the developer or contractor to pay for the dirt to be hauled off. (As used herein, the term “dirt” generally refers to soils, aggregates, and other common bulk materials excavated from the earth.) In addition to the significant transport cost, the developer also pays substantial landfill fees to ultimately dispose of the dirt. This method of disposal is, unfortunately, the rule rather than the exception.

On the other hand, it is also common for a developer or contractor to be in the unfortunate position that soil or aggregate is needed. This situation often arises when a job site must be brought to grade. On occasion, the developer in need of material at one site may have excess at another site nearby, or may be lucky enough to find excess material by “calling around.” However, more often than not, the developer in need is left with only one option, to purchase dirt from a quarry. The developer then pays quarry fees and substantial hauling fees to get the dirt to the job site.

It is not uncommon that there are times when one developer may have excess dirt on his job site while another developer, only a few miles away, might have need for dirt. Unfortunately, there currently exists no reliable means for either party to identify the other. Unless somebody knows both developers, there is a significant chance that neither will find out about the other. Thus, the developer who is a potential supplier must pay to have dirt dumped in a landfill, while the developer who was a potential acceptor must pay a quarry to purchase material. Moreover, both developers must absorb the significant cost of transporting the dirt from or to their respective job sites. The expense can become very great when the dirt must be transported over a long distance.

In addition to the financial drawbacks of the conventional practice, important environmental impacts must also be considered. It is well known that landfills become filled far too quickly in the United States. Some estimate that up to 25% of all material placed in a landfill is excavation material. Much of that material is clean, and/or could be recycled for good use. In addition, the heavy hauling vehicles, which are used to transport the dirt, significantly damage public roads and produce large amounts of polluting emissions. This is to say nothing of the environmental impact of quarrying new dirt from previously undisturbed earth.

Thus, a need exists for a system for connecting potential suppliers of bulk materials with potential acceptors, a system for creating and managing an exchange of construction materials.

### SUMMARY OF THE INVENTION

The invention relates to a method for facilitating the exchange of bulk materials and/or heavy equipment. The method involves two general procedures, which can be performed in any chronological order, and are preferably performed simultaneously on an ongoing basis.

An internet-based searchable database system is provided on which professional suppliers and potential (at-large) suppliers of materials post the availability of their materials. Professional suppliers generally include businesses who have certain bulk materials for sale on an ongoing basis. Potential suppliers generally include businesses who have or will have excess materials which they might otherwise need to haul to a landfill or other disposal sight. For the sake of simplicity, both the professional suppliers and at-large providers of material are generally referred to as “suppliers” or “providers”. These suppliers of materials post certain information indicative of the material which they have or will have available, such as its composition, characteristics, location, source. Contact information for the supplier is also provided.

The database may also include postings from potential acceptors or purchasers who have need of material. A description of the need includes information indicative of the needed material, such as the required composition, characteristics, and the location where it is needed. For the sake of simplicity, the term “purchaser” also includes businesses or individuals who might acquire materials for no fee. Potential acceptors can also view the postings by the suppliers to determine if any sources of excess material exist which meet their current or future needs. If no compatible material is immediately found, the system is designed to provide future notices to the potential acceptor when material is posted which meets the potential acceptor's identified needs.

The system is designed to search the database to compare the postings of the needs with postings of the excesses. When information about excesses or needs is found which corresponds with a user's need or excess, the information is displayed to a user in a meaningful way.

The present invention provides a novel system for facilitating the exchange of various materials. The system provides storable and searchable data, as well as the ability to send and receive notices of needs and availability of materials. Through automatic searches provided by the system, matches are quickly found and notifications provided to the users.

The foregoing and other features of the invention and advantages of the present invention will become more apparent in light of the following detailed description of the preferred embodiments, as illustrated in the accompanying figures. As will be realized, the invention is capable of modifications in various respects, all without departing from the invention. Accordingly, the drawings and the description are to be regarded as illustrative in nature, and not as restrictive.

### BRIEF DESCRIPTION OF THE DRAWINGS

For the purpose of illustrating the invention, there is shown in the drawings forms which are presently preferred; it being understood, that this invention is not limited to the precise arrangements and instrumentalities shown.

FIG. 1 is an overview of a novel system according to the present invention for facilitating the exchange of bulk materials.

FIG. 2 is a flowchart showing some details of a preferred embodiment of a method according to the present invention.

FIG. 3 is a preferred embodiment of the method according to the present invention.

FIG. 4 is a preferred embodiment of a displayed result of a search of materials needed according the present invention.

FIG. 5 is a preferred embodiment of a displayed result of a search of materials available according the present invention.

### DETAILED DESCRIPTION OF THE PREFERRED EMBODIMENTS

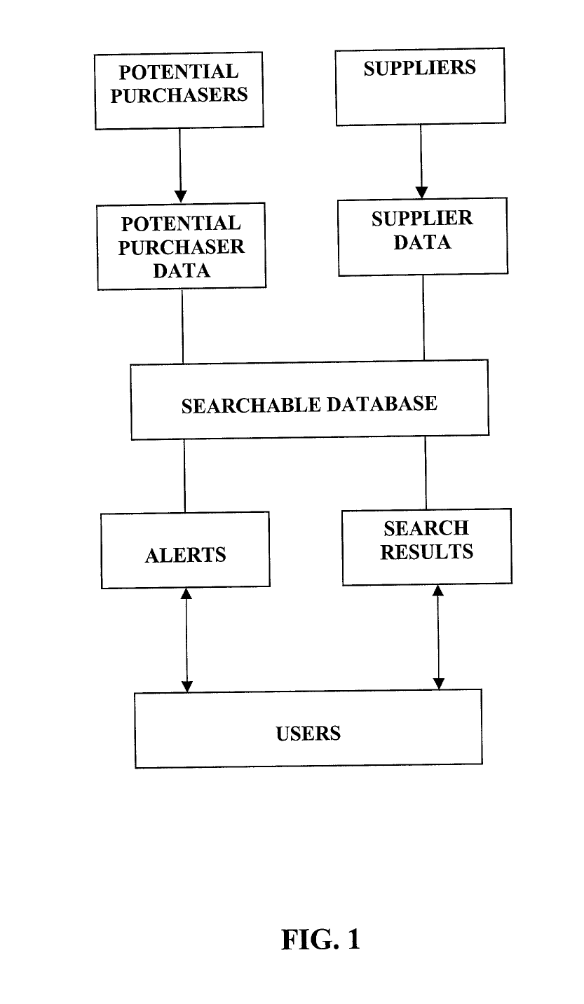

Referring now to the Figures were the details of the invention are shown, FIG. 1 illustrates an overview of the system according to the present invention for exchanging bulk materials, such as excavation and heavy construction materials. The system includes a searchable database that includes user data that can be searched by or for a user from a remote location. The system is designed to provide information to the user form the database in a useful, efficient and timely manner. Ideally, the database is in communication with an Internet host, such that remote users may be provided access to the database via the Internet. As will be described in more detail below, the system includes a user interface for inputting data from the user and outputting data to the user.

More specifically, the database 10 includes supplier data (i.e., available material data) 12 and potential acceptor data (i.e., material needed data) 14. The supplier data is preferably provided by or related to two primary sources of material. The first is professional suppliers, such as quarries or equipment suppliers. These suppliers, for the most part, always have the supplied material available or can have it available on short notice. The second type of supplier is an at-large supplier. This is a supplier who temporarily has material available, such as an excavation site or a business looking to sell off excess or no longer needed equipment. Both of these suppliers are identified as 16 in FIG. 1.

The potential purchaser or acceptor data 14 is provided by or related to user's who have need for certain materials. These individuals are generally looking for particular types and limited quantities of material. Of course, potential acceptor's according to this invention also include acceptors who might consistently be in need of certain types of material, such as recycling facilities. The information regarding the materials needed by the potential acceptor is input into the database, preferably by the potential acceptor 18.

Although the searchable database is referred to as a single database, it may and in many cases does include numerous databases of information. As such, the supplier data 12 and potential acceptor data 14 may be in separate databases which are all part of the general searchable database. As will be explained in more detail below, the information that is input into the database is searched for matching data. A list of matches is provided in a sorted manner. Preferably the information is sorted by distance from the user's selected location.

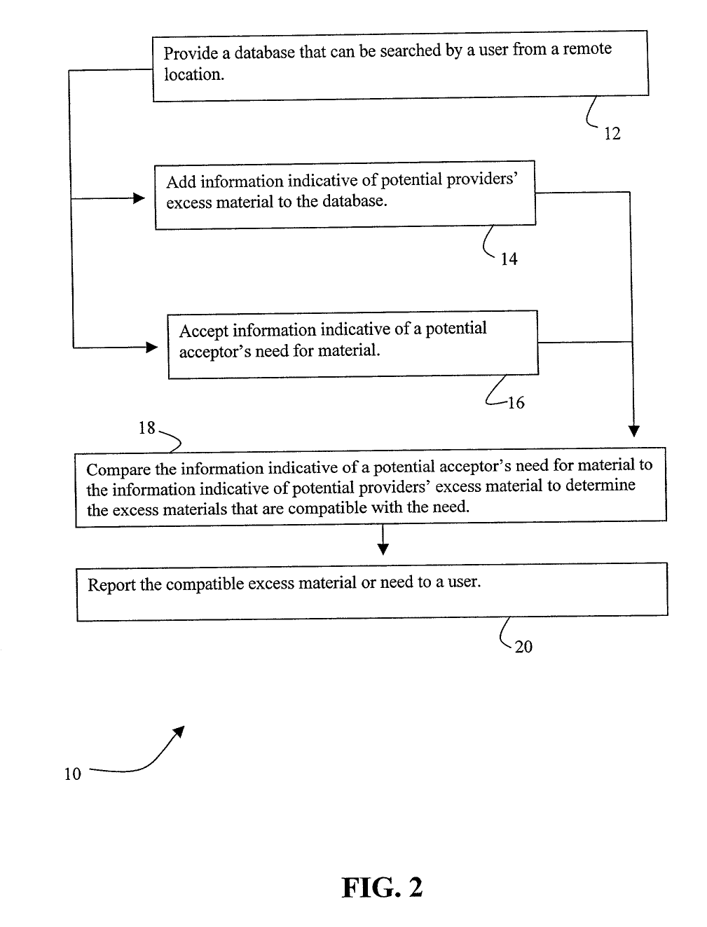

Referring now to FIG. 2, a method 10 for facilitating the exchange of bulk materials is shown. As shown steps 14 and 16 involve the entry of data. It should be apparent that in using the exchange system described, the steps need not be performed in any particular order. In fact, use by the invention of a potential acceptor will not necessarily involve the entering data by a supplier since such data may be entered in a subsequent or previous step by a supplier. The steps can also occur simultaneously since the system is preferably an internet based system and, as such, multiple users can be accessing the system at the same time. The steps are also preferably repeated on an ongoing basis.

Step 14 is the step of adding information indicative of potential suppliers' excess material to the database. As noted above, a potential provider may be a developer or contractor who has excavated or in the future will be excavating dirt in preparation for a commercial construction project, and has no appropriate place on site to redeposit excess material. Other potential providers include municipalities that perform various material removal operations, such as large scale dredging projects, some of which produce tens of millions of cubic yards of nutrient-rich material. Faced with the prospect of paying hauling fees to remove the excess material, landfill fees to finally dispose of it, and in light of the environmental consequences of those actions, the potential provider instead turns to the method of the present invention. Another potential provider is a professional quarry, excavation machinery supplier or similar entity that has bulk materials that it desires to sell.

The potential supplier provides information for entry into the database regarding the material, such as the type and quantity of material available or which is anticipated to be available and when, the location of the material, the classification of the material including its characteristics, and contact information. The supplier can enter the information itself into the database using a user interface, or the information may be entered by a party designated to do such. The information indicative of the material is entered and stored into the database in a way that can be searched by others looking for such material. Also, as will become apparent below, the system searches the database for matches, i.e., potential acceptors who indicated a need for the particular materials just entered. If a match is found, an alert is sent to the potential acceptors indicating that a supplier has posted materials that meet the acceptor's previously entered needs.

It being understood that one person's refuse could always be another's treasure, the method of the present invention could be used with quantities of many materials, ranging from chemical by-products to animal waste. However, as will become abundantly clear, if not so already, the method of the invention is ideally suited for bulk materials, which includes not only large or voluminous materials that are costly to ship long distances, but also materials with relatively little value per unit of weight in comparison to relatively large costs to acquire, transport, and dispose of the material due to the large amounts of the material typically handled.

In one embodiment of the invention, potential acceptors of material may review the postings to determine whether materials are available that are compatible with a need that they have. A typical potential acceptor may, for example, be a developer who requires material to bring a site to grade in preparation for a construction project. It should be understood, however, the range of needs is not limited to simply fill material. It is contemplated that the potential acceptor may have a variety of needs, for example, materials for use in construction of offshore airports, large amounts of construction or building equipment (such as windows, doors and plumbing materials), and other raw material needs in manufacturing. Similar to the alternatives faced by the potential supplier, the potential acceptor is faced with the prospects of paying quarry fees, hauling/transporting fees and also considers the environmental impact of the contemplated activities.

As noted above, the complement to step 14 is step 16, i.e., providing information indicative of potential acceptor's needs for material. This step is particularly useful when a preliminary review of the postings reveals no suitable materials that meet the particular need, or in the case where the potential acceptor does not have the time or the inclination to review the list of posted materials available. The potential acceptor provides information indicative of its particular need. Such information may include the location of where the material is needed, the class of material needed, amount of material needed and when, required characteristics, and contact information for the potential acceptor. As with the supplier, the potential acceptor can enter the information itself into the database using a user interface, or the information may be entered by a party designated to do such.

As discussed above, once information has been inputted, the information may be immediately compared with information stored in the database. For example, after a potential purchaser enters their needs into the database as a posting, the system searches stored data indicative of potential suppliers' available material. The comparison step is shown as step 18 in FIG. 1. Alternatively, the information indicative of need can be stored in the database and later compared to current or future posts of information indicative of available material. Preferably, the comparison is immediately run, and the information is also stored for further comparison or use later. The comparison step specifically compares the need of a potential acceptor/purchaser to the information currently stored regarding materials that are available (or anticipated to be available), taking into account such things as the distance between the location of the material and the site of the need, and the compatibility of the material. To put it another way, the system searches the database for data that meets the user's post (i.e., available material that meets a potential purchaser's needs or potential needs that meet a supplier's posted excess.) A set of compatible material posting results (e.g., hits) is determined based on the information entered, for example, the potential purchaser's identified needs and limitations (e.g., quantity, timing, distance). Of course, the resulting set of “matches” may, at times, be “no matches” or “one match”.

The final step is shown as step 20. The final step is not necessarily the conclusion of the method, but rather the production of a result for a user. The result is the reporting to the user of a list of matches or hits. For a potential purchaser, the list would be of compatible materials that are available. The list is preferably organized in a way that is meaningful to the user. For example, the compatible materials may be sorted by certain criteria, such as by the respective distances that the material is located from the potential purchaser's job site, or by particular characteristics of the materials themselves.

While the above description has primarily discussed a search by the system for a potential purchaser's particular needs, it is should also be understood that the system is equally intended to provide results to potential suppliers of potential purchaser's who meet the supplier's needs (i.e., need to sell certain material). After a user enters information of a need or an excess, the system continuously monitors and searches entered data to see if a match is found. So a potential purchaser may receive periodic lists of search results until the potential purchaser removes its posting, or other indicates that its needs are met.

As described above, the basic form of the preferred embodiment involves a system that includes a database which stores data from users based on materials that potential suppliers have available and materials that potential acceptors need. The potential suppliers input the materials that they have available on the database (or identify the date that the material will be available.) The potential acceptors identify the materials that they need. The system, preferably on an on-going basis, monitors the information that is inputted (e.g., posted) by both the potential purchasers and potential sellers and provides notice to the user when its needs (e.g., whether it be to sell or buy) is matched.

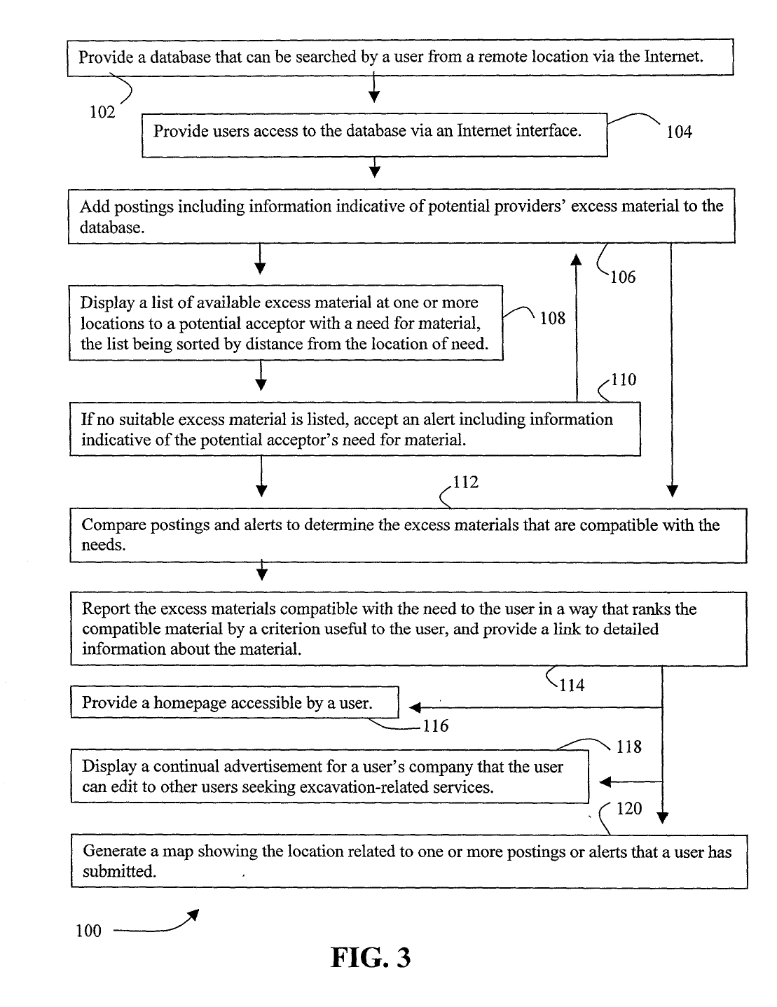

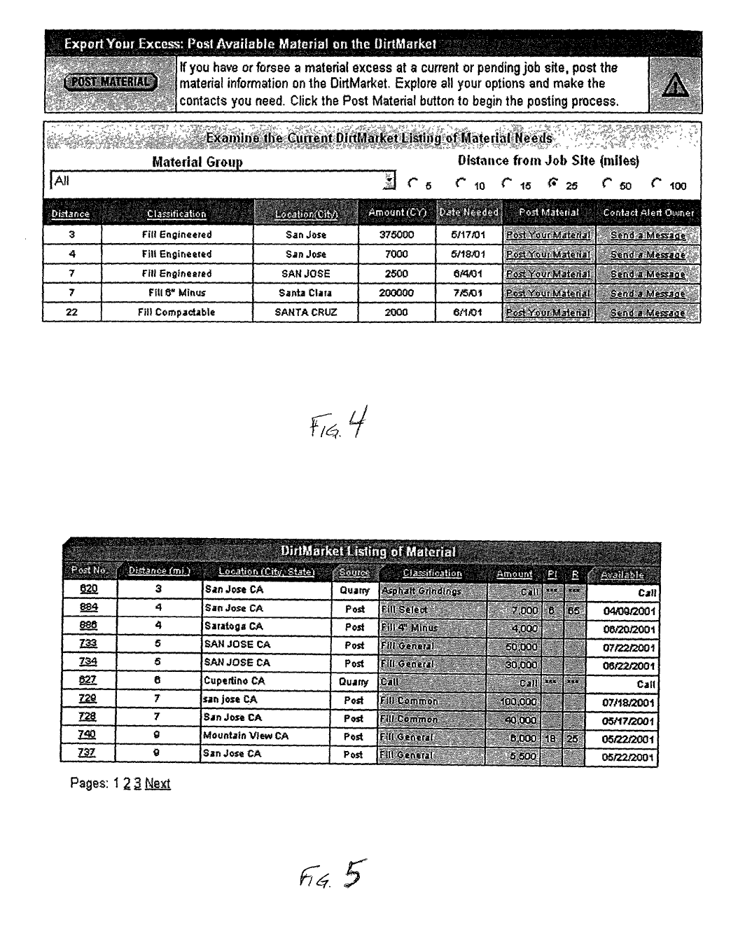

Having described the basic form of a preferred embodiment, the most preferred embodiment, as it is currently contemplated, will now be described with reference to method 100 shown in FIG. 3.

The database, which is provided in step 102, is maintained on an Internet host, or in communication with the host. The Internet host allows users to remotely access the database by visiting a web site. It is well known that the Internet is an excellent tool for exchanging all kinds of information. Utilizing the Internet in implementing the present invention provides the ability to incorporate a user-friendly interface, i.e. the web site. This, in turn, provides the opportunity to present a large amount of useful information in such a way that it can be understood and evaluated rapidly by a user. This opportunity becomes beneficial in later steps of the method, which are described below. Once the web site and database are set up, information can be solicited from potential suppliers and potential acceptors of available material. The database is part of a computer system that is preferably stored in memory or similar storage medium in one or more computers or signal processors. Such computer systems are well know to those skilled in the art and, thus, details of the system need not be discussed.

As shown in step 104, a group of users, who are typically potential suppliers or acceptors of material, are provided with access to the web site through the Internet. Providing access typically involves setting up a user account which includes collecting information about the user, such as the user's name, company name, address or other contact information, and job site locations. This information is stored so that it can later be associated with information submitted by the user indicative of excess material or a need for material. By setting up an account for each user, various features of the method, described below, can be employed. Although a user is typically required to set up an account to enjoy the full benefits of the invention. Limited access can be provided to guests who do not have accounts. Limited access might permit only limited searching of the database of posting. Other limitations may be employed depending on the materials being marketed.

Step 106 is similar to step 14 of the method 10. Step 106, which is performed on an ongoing basis as the method is carried on, involves accepting postings. A posting represents information indicative of a potential supplier's available material at a particular location. Postings may be of two or more types. Different types of postings contain varying degrees of detail regarding characteristics of the material. A quick posting includes basic information that sufficiently describes the material available, such as the material classification (e.g., clay, asphalt grindings, top soil, fill general, etc.), the date the material is available, the amount of material that is available, location of the material, and contact information for the potential supplier. A detailed posting includes the same basic information and further includes other information that may be of interest in choosing the material. For example, information such as a Unified Soil Classification Group (USCG) symbol, plasticity index, resistance value (R-value), sand equivalent (SE), dry density, liquid limit, gradation percents remaining on ¾ inch sieve and passing on 200 sieve, optimum moisture content, current moisture content, soil reports, name of soil engineer, contact information for soils engineer, hazardous materials test performance and results, structural, geotechnical characteristics and site access information. Generally, information is provided which facilitates the exchange. If the user submitting the posting anticipates that the material must be removed from the site by a certain date, the user may also provide that date, indicating how long the posting should remain active (alive in the system). If no acceptor for the material is ultimately identified in the specified time, the material can be hauled to a landfill as a last resort and the posting and alerts are deemed inactive. Once the user completes the information, the information is stored into the database and, depending if the user elected to send an alert, an alert is sent to interested members on the system about the newly posted information.

In order to provide consistency in postings, some of the listed data can be grouped according to commonly accepted terms in the region. For example, the preferred system includes an indexing system for categorizing and subcategorizing preferred characteristics for identifying certain materials. When inputting in data regarding materials needed or available, the user selects the preset material identifications that most closely represents the material that is available (or needed). For example, a drop-down table or menu is provided that might include asphalt grindings, clap, bay mud, fill 4″ minus, fill 6″ minus, fill common, fill compactable, fill engineered, fill general, fill organic, fill select, millings, other soil, stripings, and topsoil. These are terms well understood in the construction materials field.

Subcategories can also be provided which include preset further characteristics of the material.

It is also contemplated that the system can include a database of region specific terms and conditions. For example, there may be certain materials which have characteristics the definition of which varies from state to state or region to region. In such cases, the system separates the standard characteristics by state or region and displays the appropriate one based on the location of the person either inputting the data or reviewing the data. Thus, the system is also capable of providing standard terms based on the location of the individual posting the material, and may adjust the description based on the location of the person viewing the posting to account for different regional understandings of the terms. As such, the system displays data with regionalized settings and terms.

When a potential acceptor discovers a need for bulk material, the potential acceptor accesses the web site via the Internet. The potential acceptor selects an option to view postings of available material and optionally provides the location where the material is needed. The system preferably allows the user to store one or more job site locations (or other types of locations) for subsequent quick searching. As such, the potential acceptor can set a specific site as a default site. When the user logs into the system each time and selects to view postings, the system will automatically conduct a search based on the users default site. The system can also permit the user to quickly select other sites using a drop down menu.

The system provides the potential acceptor with the ability to refine the postings displayed by limiting them to specific characteristics, such as the date available, type of soil (or aggregate), geotechnical characteristics, or by geographic distance of the excess material from the location of the need. As shown in step 108, a listing of the relevant postings, sorted by distance, is displayed to the user.

The distance between the locations of interest can be calculated using a tool which translates location defined by an address (provided by the users) to location defined by code. U.S. Pat. No. 6,282,489 to Bellesfield, et al., which is incorporated herein by reference, discloses such a system. This operation is related to proximity search techniques well known to those skilled in the art. The proximity search engine may be powered by commercially available sources, such as MAPQUEST, a registered service mark of Geosystems Global Corporation of Lancaster, Pa.

The list generated in step 108 includes links corresponding to each listed posting. Selecting a link causes a detailed description of the posting to be displayed, including all of the relevant information indicative of the excess material submitted in step 106. In addition, the detailed view of the posting may include an option to notify the potential supplier of the excess material, such as by e-mail, fax, notification on pager, PDA or phone. Hence, the system provides for prompt contact between the potential acceptor and the potential supplier in order to facilitate the exchange. Of course, the system can also permit users to select the types of notifications they wish to receive of potential matches to their post. When selected, the e-mail option automatically generates an e-mail form including the e-mail address of the potential supplier, the posting number (which is the identifier of the particular post) and any other relevant information, such as the supplier's job site where the excess material is located or needed. The user selecting the e-mail option composes a message indicating a desire or offer to acquire the material, or a query related to the material and conveniently sends the e-mail. The system can track e-mails sent for each user and/or each posting number in order to allow the user to obtain a periodic history of actions/queries. The tracking can also be used with the other types of notification discussed above.

Step 110 is similar to step 16 of method 10 and is performed if no suitable excess material or need are revealed in step 108 or if the user desires to send a general alert or request for particular material or need instead of reviewing the search results. Step 110 involves accepting input information regarding the alert to be submitted. An alert may be similar to a posting. An alert can include information indicative of the need or excess material available, including any or all of the following: contact information for the person sending the alert (an email address will due), a time period for the alert to remain active (alive in the system), place where material is needed or located, size of searchable region around the location of the need or material, classification of material needed or available, amount needed or available, start date of the alert, characteristics of the material, such as acceptable plasticity index range, and acceptable R-value range. Once the alert has been accepted, it is stored in the system.

Each time a new posting or alert is submitted, a search of the database may be performed to identify any compatible excess material or need. In addition, all of the active postings and active alerts are periodically compared to determine any excess materials that may be compatible with the needs, represented by step 112.

When one or more postings is determined to be compatible with an alert, the user who submitted the alert is notified to that effect, as seen in step 114. As discussed above, the user is notified via e-mail, telephone, pager, facsimile, or any other means that the acceptor specifies. Ideally, the comparison finds multiple compatible postings. When that is the case, the compatible postings are reported to the user ranked by some criterion, for example distance between the location of the material need or excess and the job site of the user. Of course, the user can also be notified of compatible alerts.

When one or more posts and alerts are found to be compatible, the user is provided with a list of the relevant hits. A sample listing is provided in FIG. 3. The reporting of compatible postings/alerts to a user is sorted by relevant criteria. By default, the sorting criterion is distance between the location of the need and the location of the available materials. The distance is important to many users because the cost of transporting the material increases significantly as the distance grows. In fact, at long distances, the prospective transport cost can be prohibitive. The report also includes a link to detailed information about each listed posting. By selecting the link, the potential acceptor is shown a detailed material-listing page. This page includes all of the relevant information about the material that was submitted with the related posting, such as such as the plasticity index, resistance value (R-value), sand equivalent (SE), dry density, etc. Thus by clicking on the link, the potential acceptor can quickly ascertain whether the available material adequately fills the need. The detailed material-listing page may also include certifications and/or contact information for the potential purchaser to verify the quality and/or environmental state of the material being offered.

Another step 116 in one embodiment of the system, is to provide a homepage accessible by each user. The homepage is unique for each user and quickly identifies large amounts of information important to the individual user in real-time. The homepage displays a membership header for the user, the user's activity, total community activity, links to other pages and services, and other information such as customized local weather information for relevant job sites. The membership header may include the user's name and a menu of job sites that the user has inputted into the database. Links are provided to enable the user to add more job sites or edit existing ones. Furthermore, additional links are provided that enable the user to create or edit an on-line advertisement for the user's company or services to be displayed to other user's of the database (the display is explained below with reference to step 118). Other important information to the user can be displayed, such as the number of active postings the user currently has, the number of active alerts, the number of responses to active postings, and the number of matches for active alerts. The community information may include information related to the user's local market (a pre-selected geographic area), such as the total amount of excess soil reported in postings, the total amount of soil needs reported in alerts, the total amount of excess aggregate available, and the total need for aggregate. It is contemplated that any real-time information of interest to the user could also be listed by adding the appropriate links.

The homepage provides the user with the ability to manage its postings and alerts, while also permitting the user to manage the information being displayed to the marketplace. When another user performs a product search, the displayed ads and posted information is the most up to date available.

Also, professional suppliers can use the homepage to control the list of materials that they offer on one or more pages. Thus, the company does not need to modify individual postings as data changes but, instead, control data at a company level. At-large suppliers would select specific postings to modify and, thus, manage each posting on a discrete basis.

As indicated above, a user with an account has the option to create job sites. Such job sites are virtual job sites which correspond with actual sites. By providing the location of the site, the user can later create postings and alerts and select the appropriate job site from a pull down menu, table or index of project locations, rather than re-entering location information. It is contemplated that the job sites can be displayed to other users of the system as well. In doing so, a developer of a site can utilize the web site to advertise the need for a contractor (or a contractor for subcontractors) and solicit bids online. Such on-line bidding may be carried on at a distinct section of the web site, linked to the pages described herein.

The on-line advertisement (shown in step 118) is a continual advertisement that is posted for users who are looking for a provider of a particular service or trade related to the materials being traded, including providers of supplies and equipment. The advertisement allows communication of information about the advertiser to customers and potential customers anywhere in the world. The advertisement is built on a template specifically designed for some segment of the industry, for example trucking, equipment rental, or excavation industry, thus enabling a user to change the advertisement through simple editing of text fields, without using programming language, such as HTML.

The system preferably includes an advertisement page with text boxes embedded therein. The text boxes allow entry of text using a conventional word processor. A unique template layout is preferably designed for each type of service related to the exchange of materials. Most templates will have the same basic information such as the name of the service provider, the company's logo, description of the company and the contact information for the company. The templates differ, however, in the space provided for substantive content. For example, a template for equipment manufacturers may have a text box for listing equipment specifications, whereas a template for a quarry may have a box for listing materials available and the required lead-time for the various materials. Thus, the fields of interest for the service provider are supplied on the template designed for the particular provider's type of service. The system may also includes links on the web site related to the advertisement. For example, one link can be to the user's homepage for accessing information that supports the on-line advertisement, such as pricing.

In use, a person accessing the web site may request a search of companies offering a particular type of service or have a particular type of machine. The system searches the database of advertisers and provides a list of results to the user. Again, the list can be categorized or indexed based on any suitable criteria, such as distance from the user's job site. In addition to being sorted by distance from the need, the providers/suppliers may be grouped by classifications, such as subscribers (users) of the service, paying advertisers, and suppliers who are not paying advertisers. The list in turn has corresponding links, which, when selected, display any available on-line advertisement for the corresponding supplier. For example, on link would provide a link to the company's advertisement on the system which would display the information that was provided in the template described above. For convenience, the system also can include drop down menus, tables or other indexes on the advertising page under the section related to goods being offered. The drop down menu/index permits the user to select the type of product or service of interest from the list, and the associated materials, rates, etc. related to the selected item would be displayed.

Another feature of the method 100, is the ability to generate a map showing various job sites. The map shows the location of job sites, quarries, landfills and other relevant places in relation to one another. In addition to maps, printed written or graphical directions may be provided. Maps and directions may be produced using the same tools as used for calculating distances, noted above. In addition, estimates of transport costs may be determined using the distances calculated, and displayed on the map near the related location.

In addition to the many novel features described above, the method of facilitating exchange described herein may solve additional problems faced by suppliers of construction-related services. For example, a municipality may require that a contractor recycle or reuse asphalt if a paved surface is torn up, and further that the contractor provide a third party certification that the recycling was completed. The City of San Jose has instituted such a program, requiring certification that at least 50% of materials related to construction and demolition be recycled for reuse. In order to certify the reuse of the materials, the only conventional way has been for the contractor to track everything and maintain a paper trail of the transport and sale of the materials.

The present system is being used to facilitate the certification process. In particular, the contractor posts the materials to be recycled and when they will become available. For the purposes of this example the materials will be described as asphalt. However, any construction or demolition materials may be used in the present system. Once the materials are posted, the system provides a list of potential purchasers of the material. The contractor can then negotiate the sale of the materials. Alternately, the contractor may utilize the services of an asphalt recycler found through the system's service providers directory (described above as the advertisements related to step 118). The ideal recycler is usually the closest recycler to the job site, which is easy to identify using the distances and mapping features provided.

Once the contractor has a purchaser of the materials or has found a recycling service that will recycle the materials, the system permits the exchange of the materials to be tracked. When the recycling is complete, the recycler and/or contractor provide the necessary paperwork, such as trucking records, certification of receipt of materials, etc., to the system operator. The system operator than reviews the materials and provides a certification to the contractor or directly to the municipality indicating that the materials of interest have been recycled as required. This aspect of the invention has tremendous utility for municipalities which otherwise would need to hire individuals to track and verify all recycling efforts by contractors. This aspect of the system also benefits the contractor since it eliminates the need to track and maintain paperwork related to the recycling. The system can provide updates on where the materials are in the overall the process of recycling, e.g. in transit, at recycler, etc.

In addition to certifying recycling activities, the method operator can serve as a certifying agent for other matters. For instance, contaminant levels and soil engineer reports for materials exchanged using the present method can be reported on the web site or certification can be provided when reports are added if required by a governing authority. Using the present invention, numerous other methods of solving a broad range of problems faced by contractors and service providers should be readily apparent.

Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method of facilitating the exchange of bulk materials, the method comprising the steps of:
providing a searchable database;
adding information indicative of potential suppliers' excess material to the database;
accepting information indicative of a potential acceptor's need for material;
comparing the information indicative of a potential acceptor's need for material to the information indicative of potential suppliers' excess material to determine the excess materials that are compatible with the need; and
reporting the compatible excess material or need to a user.

2. The method of claim 1, wherein the adding step comprises the step of recording location, characteristics, and contact information for the potential supplier of the excess materials.

3. The method of claim 1 wherein the accepting step comprises receiving information indicative of a location where material is needed.

4. The method of claim 3 wherein the accepting step further comprises the step of receiving a geographic distance away from the location where material is needed, the distance representing a limit of how far compatible material may be located from the location where material is needed.

5. The method of claim 1 further comprising the steps of:
gathering information about suppliers of one or more services related to the material, the type of information that is gathered being particularly associated with the type of services being provided; and
displaying advertisements for selected suppliers of a particular service about which a user who desires that service inquires, the displayed information being based on the gathered information.

6. The method of claim 5, wherein prior to the step of displaying, the method comprises the steps of:
searching a directory of service providers in response to a user query for providers of a particular service;
providing a list matches from the directory of service providers that provide the particular service, the providers being sorted by the distance of each provider from the location of the user's need;
wherein the displaying step is performed in response to the user's selection of a particular provider from the sorted list.

7. The method of claim 1 wherein the providing step includes the steps of:
establishing the database on a computer connected to the Internet, and
providing a web page interface for a user to access information from the database from a remote computer.

8. The method of claim 7, further comprising the step of allowing users access to the database by establishing user accounts.

9. The method of claim 8 wherein the allowing step comprises the step of charging a fee for subscriptions to establish the user accounts.

10. A system for facilitating the exchange of excavated material, the method comprising the steps of:
providing an Internet host capable of storing information indicative of available materials at locations of a first group and needs for materials at locations of a second group;
receiving information from potential suppliers indicative of available excavated materials at a plurality of locations;
receiving information from a potential purchaser indicative of a need for available excavated material at a location;
comparing the information indicative of the potential purchaser's need to the information indicative of available materials to identify available materials that are compatible with the potential purchaser's need; and
reporting to the potential purchaser a list of available material that meets the potential purchaser's need.

11. The system of claim 10 wherein the system further comprises the step of writing to computer memory the locations of the available materials, characteristics of the materials at each location, and contact information for the potential supplier of the available material at each location.

12. The system of claim 11 wherein the information indicative of the need for materials includes information indicating the location where material is needed.

13. The system of claim 12 wherein the comparing step further comprises the step of determining the distances between the location where material is needed and the locations of the available materials, and wherein the reporting step includes the step of sorting based on distance the available materials that meet the potential purchaser's need.

14. The system of claim 11 wherein the step of receiving information from a potential purchaser comprises the step of storing in computer memory information indicating the location where material is needed.

15. The system of claim 14 wherein the comparing step further comprises the step of periodically evaluating the needs for materials and the available materials to identify any compatible available materials and needs.

16. The system of claim 15 wherein the reporting step comprises sending an email to the user when a compatibility is determined.

17. The system of claim 15 wherein the reporting step comprises contacting the user when a compatibility is determined, the step of contacting the user involves performing an action selected from a group consisting of telephoning the user, sending the user a facsimile, sending the user a text message, and sending the user a phone page.

18. The system of claim 10 further comprising the step of providing a user homepage, the user homepage displaying information previously selected by the user and information related to the user, the information related to the user including a list of the particular user's job sites and information related to the user's activity on the system including number of active search requests that the user has submitted.

19. The system of claim 10 wherein the reporting step further includes the step of listing available materials sorted by distance from a location where material is needed.

20. The system of claim 19 wherein the reporting step further comprises the step of providing links to detailed descriptions of the listed available materials.

21. The system of claim 20 wherein each detailed description includes characteristics of the available material and a link which provides an email page preaddressed to the potential provider of the material for contacting the provider about the available material.

22. The system of claim 10 further comprising the steps of:
providing a plurality of computer user interfaces, each computer interface being tailored to a particular service, each computer interface having text boxes for entry of text by a service provider related to the particular service for which the computer interface was configured;
allowing service providers to select one of the computer interfaces for supplying advertising information for an on-line advertisement; and
displaying, in response to a user command, a list of service providers of a particular service, the display including links to at least some of the listed service providers' on-line advertisements.

23. The system of claim 22 wherein the list is sorted by the distance the providers are located from a specific location.

24. A method of facilitating the exchange of bulk materials, the method comprising the steps of:
providing searchable computer memory;
storing in memory postings indicative of excess bulk materials at a plurality of job sites;
displaying one or more of the postings in response to an input of a particular need by a user for excess materials;
accepting alerts from users regarding a need for excess material;
comparing the alerts and postings to determine if any excess materials are compatible with any needs identified in the alert; and
reporting the compatible excess material to the user.

25. The method of claim 24, further comprising the steps of
providing a plurality of user interfaces, each interface being configured to receive information related to a user and a particular service, each user interface having sections for receiving textual information pertinent to the particular service for which each interface was designed;
receiving and storing information inputted by the service providers using the user interfaces;
creating on-line advertisements for at least selected service providers, each advertisement being based at least in part on the received information; and
displaying a list of providers of a particular service in response to a user selection, the list including links to at least some of the provider's on-line advertisements.

26. The method of claim 24 wherein each posting comprises the location of the excess material, characteristics of the material, and contact information for a potential provider of the material.

27. The method of claim 26 wherein the displaying step comprises producing a list of postings within a selected distance of a location where material is needed.

28. The method of claim 27 wherein the selected distance is chosen by a user and wherein the list is sorted by the respective distances between the locations of excess materials and the location of the need.

29. The method of claim 27 wherein the displaying step further comprises the step of providing links to a detailed description of at least some of the postings.

30. The method of claim 29 further comprising the step of displaying the detailed description of a posting in response to the selection of a link being selected by a user.

31. The method of claim 30 wherein each detailed description of a posting includes an option for a user to respond to the posting.

32. The method of claim 31 further comprising the step of producing a homepage individualized for a particular user, the homepage including a list of the particular user's job sites, indications of a quantity of alerts submitted by the particular user that are still active, a quantity of postings submitted by the particular user that are still active, a quantity of responses to the particular user's postings, and information selected by the user.

33 The method of claim 32 wherein the indication of the quantity of responses to the particular user's postings includes a link which when selected displays a list of the particular responses to the user's postings.

34. The method of claim 26 wherein the displaying step comprises producing a list of postings indicative of excess materials having one or more selected characteristics.

35. The method of claim 34 wherein the selected characteristics are selected by a user.

36. The method of claim 24 wherein the reporting step comprises sending an email to the user.

37. The method of claim 24 wherein the reporting step comprises contacting the user when a compatibility is determined, the step of contacting the user involves performing an action selected from a group consisting of telephoning the user, sending the user a facsimile, sending the user a text message, and sending the user a phone page.

38. The method of claim 27 further comprising the step of providing a homepage individualized for a particular user, the homepage including a list of the particular user's job sites, indications of a quantity of alerts submitted by the particular user that are still active, a quantity of postings submitted by the particular user that are still active, a quantity of responses to the particular user's postings, and information selected by the user.

38. A storage medium encoded with machine-readable computer program code, the computer program code for directing a computer to perform the steps of:
receiving posting indicative of bulk materials that are or will be available at particular locations;
storing the material postings;
receiving postings indicative of a need for bulk materials at particular locations;
storing the need postings;
receiving inputted information from a user of either a need for material or availability of material;
searching the database in response to the user inputted information for need or material postings that are responsive to the user inputted information; and
displaying the responsive postings, the displayed postings including a calculated distance between a user selected location and a location associated with each posting.

40. The storage medium of claim 39 wherein the bulk materials are soil.

41. The storage medium of claim 39 wherein the bulk materials are selected from a group consisting of excavation materials, asphalt grindings, and earthwork.

42. A storage medium encoded with machine-readable computer program code, the computer program code for directing a computer to perform the steps of:
receiving information indicative of potential suppliers' excess bulk material;
storing the excess bulk material information in a database;
receiving information indicative of a potential acceptor's need for bulk material;
comparing the information indicative of the potential acceptor's need for bulk material with the excess bulk material information to determine if the excess bulk material information meets the specified need; and
displaying the excess material information if that material meets the specified need.

43. The storage medium of claim 42 wherein the information related to the potential suppliers' excess bulk material includes information of the bulk material characteristics, and wherein the information related to the potential acceptor's need includes desired bulk material characteristics, and wherein the step of comparing information involves comparing the desired characteristics with the characteristics of the excess material.
